(19) United States
(12) Patent Application Publication
(10) Pub. No.: US 2005/0059288 A1
(43) Pub. Date: Mar. 17, 2005

(54) Electrical connector with loading plate

(76) Inventors: Nick Lin, Tu-chen (TW); Jian Zhang, Kunsan (CN); Huayin Huang, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/940,283

(22) Filed: Sep. 13, 2004

(30) Foreign Application Priority Data
Sep. 12, 2003 (TW) 92216478

(51) Int. Cl. H01R 13/62; H01R 4/50; H01R 13/625

(52) U.S. Cl. 439/342

(57) ABSTRACT

An electrical connector (1) for interconnecting an LGA chip (60) with a PCB includes an dielectric housing (10) defining a number of terminal passageways (16) with a plurality of electrical contacts (12) accommodated therein, a metal reinforcement (20) enclosing the housing (10) partly, a loading plate (40) pivotally mounted to an end of the reinforcement (20), and an actuator member (30) attached to an opposite end of the reinforcement (20) for engaging with the loading plate (40). The loading plate (40) defines a pair of pressing portions (43) to press the chip (60) against the connector (1). The pressing portion (43) defines some flexible materials (431) on the bottom surface (430) toward the housing (10) for protecting the chip (60) from being scraped by the loading plate (40).

### BACKGROUND OF THE INVENTION

1. Field of the Invention

The present invention relates to an electrical connector, and more particularly to an electrical connector for electrically interconnecting an electronic package such as a Land Grid Array (LGA) chip with a circuit substrate such as a printed circuit board (PCB).

2. Description of the Prior Art

LGA electrical connectors are widely used in personal computer (PC) systems to electrically connect LGA chips with printed circuit boards (PCBs). A typical LGA connector usually comprises a dielectric housing, a multiplicity of terminals received in the housing in a generally rectangular array, a metal loading plate and a load lever attached to two opposite ends of the housing. The loading plate and the load lever work cooperatively to position an LGA chip on the electrical connector.

As a rule, the LGA chip defines an Integrated Heat Spreader (IHS) to transfer heat generated from the chip during using to a heat sink and prevent the chip from being scraped when the loading plate presses the chip against the connector.

FIGS. 4 and 5 show such an LGA connector 8 for electrically interconnecting an electronic package such as an LGA chip 100 with a circuit substrate such as a PCB (not shown).

The connector 8 comprises an insulative housing 82, a plurality of electrical contacts 81 received in the housing 82, a metal reinforcement 83 partly covering the housing 82, a loading plate 84 and an actuator member 85 pivotally mounted to opposite ends of the metal reinforcement 83, respectively.

Each contact 81 has a first contacting portion (not labeled) protruded outwardly from an upper surface of the housing 82, for electrically contacting a corresponding metal contact pad (not shown) of the chip 100.

The loading plate 84 is disposed on the housing 82 to press the chip 100 upon the contacts 81 for electrically connecting with the contacts 81 when holding the chip 100 upon the LGA connector 8. In use, the connector 8 is firstly oriented to be in an open state, the loading plate 84 standing perpendicular to the housing 82. The LGA chip 100 is put into the housing 82. Then the connector 8 is disposed to be in a closed state, where the loading plate 84 is oriented in a horizontal position parallel to the housing 82 and the actuator member 85 engages with the loading plate 84 to abut the chip 100 against the housing 82. Thus the chip 100 is stably received in the connector 8, and accordingly is electrically connected with the PCB. Because the loading plate 84 is usually formed from rigid materials, the IHS of the chip 100 is liable to be scraped by the loading plate 84 when the loading plate 84 pressing the chip 100 against the housing 82. FIG. 5 shows that the IHS of the chip 100 is scraped.

Thus, a new electrical connector with a loading plate that overcomes the above-mentioned problems is desired.

### SUMMARY OF THE INVENTION

Accordingly, an object of the present invention is to provide an electrical connector with a loading plate for interconnecting an electrical package with a circuit substrate where the connector can help prevent the electrical package from being scraped.

In order to achieve the object set forth, an electrical connector in accordance with a preferred embodiment adapted for nesting an electronic package comprises a base, a plurality of contacts received in said base, a loading plate mounted to said base for holding the electronic package. The loading plate defines a pressing portion having a bottom surface pressed the electronic package against the base. The bottom surface is attached with flexible material. Because the flexible material acts as a cushion, the loading plate formed from rigid materials contacts the IHS of the chip indirectly. Thus, the IHS of the chip is prevented from being scraped when the loading plate holding the chip against the connector.

Other objects, advantages and features of the present invention will become more apparent from the following detailed description when taken in conjunction with accompanying drawings.

### BRIEF DESCRIPTION OF THE DRAWINGS

The features of this invention which are believed to be novel are set forth with particularity in the appended claims. The invention, together with its objects and advantages thereof, may be best understood by reference to the following description taken in conjunction with the accompanying drawings, in which like reference numerals identify like elements in the figures and in which:

FIG. 1 is an exploded and isometric view of an electrical connector in accordance with a preferred embodiment of the present invention;

FIG. 2 is a bottom view of the loading plate of FIG. 1;

FIG. 3 is an assembly and isometric view of FIG. 1, showing an LGA chip having been received in the electrical connector, and the loading plate and the actuator member in a closed state;

FIG. 4 is an exploded and isometric view of an conventional electrical connector;

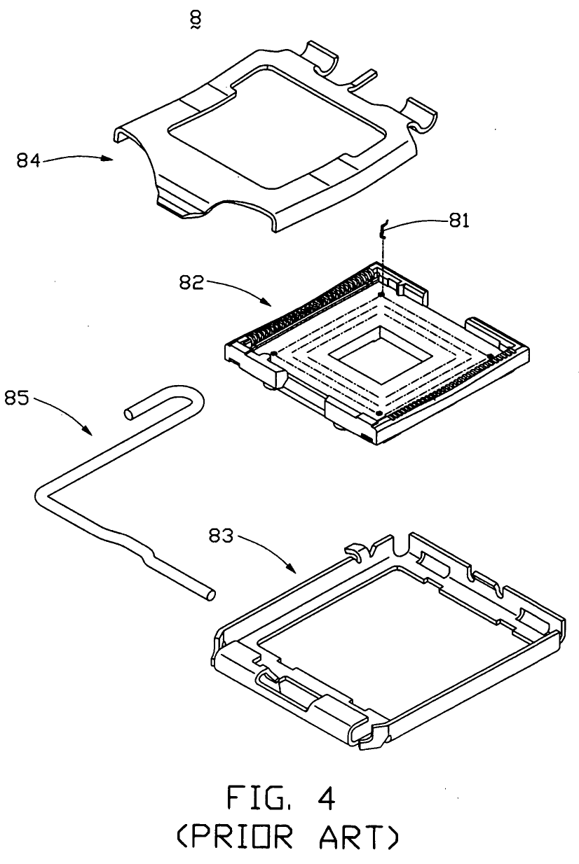

FIG. 5 is an assembly and isometric view of FIG. 4, showing an LGA chip having been received in the electrical connector, and the loading plate and the actuator member in an open state.

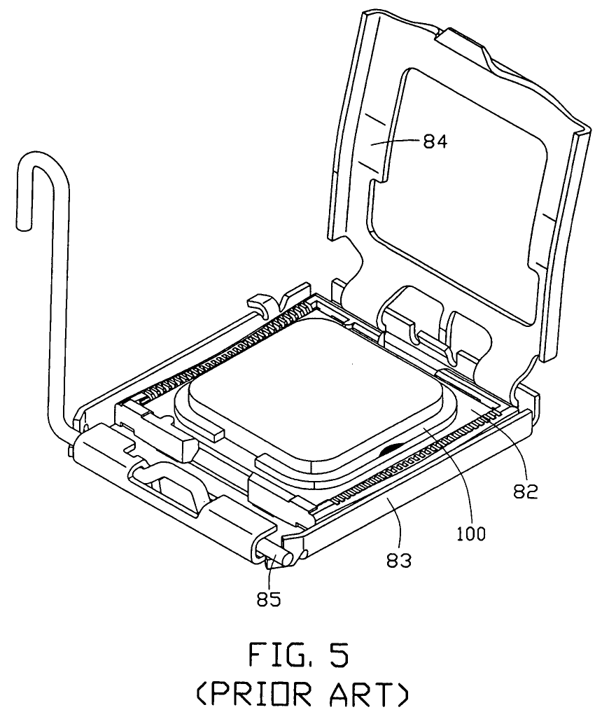

### DESCRIPTION OF PREFERRED EMBODIMENT OF THE INVENTION

Reference will now be made to the drawings to describe the present invention in detail.

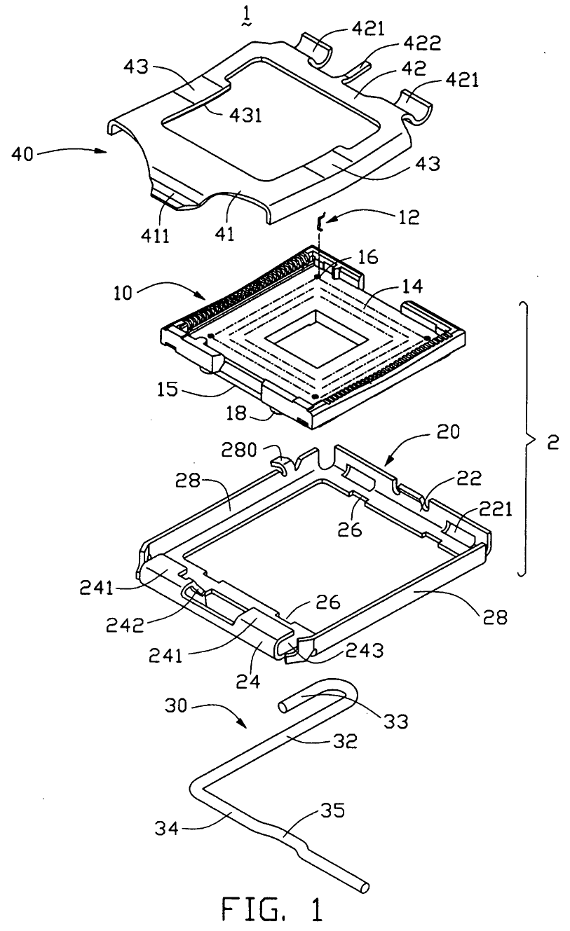

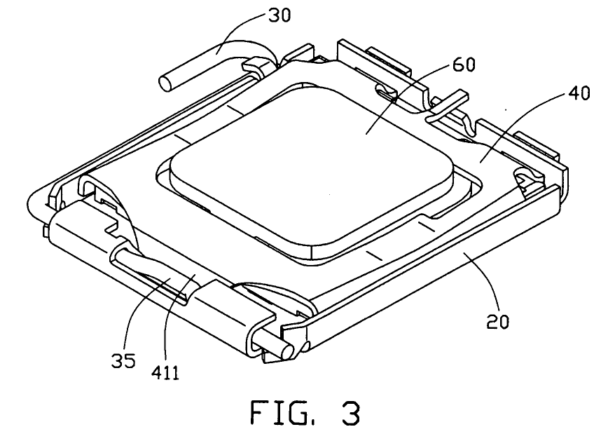

Referring to FIGS. 1 and 3, an electrical connector 1 in accordance with a preferred embodiment of the present invention is mainly adapted for electrically interconnecting an electronic package such as an LGA chip 60 with a circuit substrate such as a PCB (not shown), and comprises a base 2 for receiving a plurality of contacts 12 therein, a loading plate 40 and an actuator member 30 pivotally mounted to two opposite ends of the base 2.

The base 2 further comprises an insulative housing 10 and a reinforcement 20 partly covering and reinforcing the housing 10. The loading plate 40 and the actuator member 30 are pivotally mounted to two opposite ends of the reinforcement 20.

The housing 10 defines a generally rectangular cavity 14 in a middle thereof for receiving the LGA chip 60 therein. A multiplicity of terminal passageways 16 is defined in a portion of the housing 10 under the cavity 14 for receiving a corresponding number of contacts 12 therein. A plurality of locating protrusions 18 extend from a bottom surface 15 of the housing 10. The electrical connector 1 is electrically connected with the PCB and the chip 60 via the contacts 12 electrically contacting the metal pads of the PCB and the chip 60, respectively. Thus the chip 60 is electrically bridged with the PCB.

The actuator member 30 has an operating portion 32 and a locating portion 34 extending perpendicularly from an end of the operating portion 32. A handle 33 bends outwardly from the other end of the operating portion 32. An actuating portion 35 offsets from the middle of the locating portion 34 therefrom.

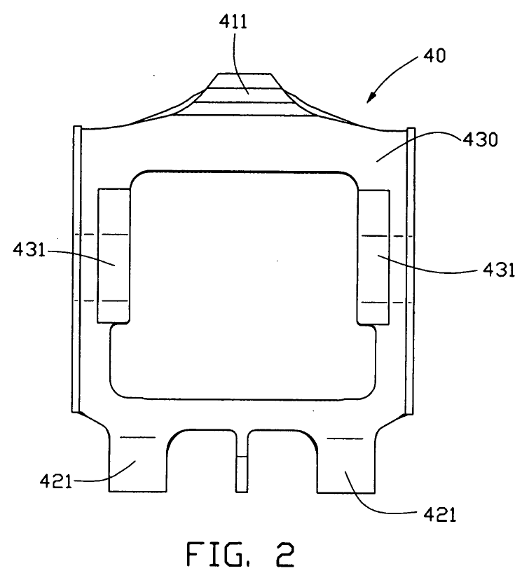

The loading plate 40 is a generally rectangular frame defining an opening (not labeled) in a middle thereof. The loading plate 40 comprises a first side 41, an opposite second side 42 and a pair of lateral sides (not labeled) interconnecting the first side 41 with the second side 42. A hook portion 411 extends from a middle of the first side 41. A pair of spaced, curved pivot latches 421 extends from the second side 42. A tail 422 extends from the second side 42 and between the pivot latches 421. Each lateral side defines a curved pressing portion 43 protruding toward the housing 10. Please take in conjunction with FIG. 2, the pressing portion 43 defines a bottom surface 430 toward the housing 10 during assembly. Some flexible materials 431 is formed at the bottom surface 430. In a preferred embodiment, the flexible material is flexible plastic.

The metal reinforcement 20 has a first side wall 22, an opposite second side wall 24 and a pair of lateral side walls 28 interconnecting the first and second side wall 22 24. Said four side walls cooperatively define a cavity (not labeled) in a middle thereof. A pair of spaced, aligned pivot apertures 221 is defined in the first side wall 22, for receiving corresponding pivot latches 421 of the loading plate 40. A pair of spaced clasps 241 bent into the cavity is formed at the second side wall 24. A securing piece 242 depends from one of the clasps 241. The clasps 241 and the securing piece 242 cooperatively work with the ends of the lateral side walls 28 to define a elongate chamber 243 for fittingly receiving the locating portion 34 of the actuator member 30 therein. A curved projection 280 extends from an edge of one of the lateral side walls 28 adjacent the first side wall 22, for hooking the handle 33 of the actuator member 30. A plurality of notches 26 is defined at an inner edge of the reinforcement 20. The notches 26 engage with the corresponding protrusions 18 of the housing 10 to secure the housing 10 in the reinforcement 20 steadily.

During assembly, the loading plate 40 and the actuator member 30 are pivotally mounted to the fist side wall 22 and the second side wall 24 of the metal reinforcement 20, respectively. The connector 1 is oriented to be an open state with the loading plate 40 perpendicular to the reinforcement 20. The housing 10 is disposed and secured in the reinforcement 20 via the locating protrusions 18 engaging with the notches 26. The handle 33 of the actuating member 30 is disposed apart from the curved projection 280 of the reinforcement 20 that the actuating portion 35 unengaged with the hook portion 411 of the loading plate 40. The tail 422 of the loading plate 40 is used to abut against the reinforcement 20, thereby preventing the loading plate 40 from being over-rotated.

When the connector 1 is positioned in a closed state, the loading plate 40 is oriented at a horizontal position parallel to the housing 10. The pressing portion 43 presses the chip 60 against the housing 10. The actuating portion 35 of the actuating member 30 presses the hook portion 411 of the loading plate 40. The curved projection 280 of the reinforcement 20 hooks the handle 33 of the actuating member 30. Thus, the chip 60 is stably received in the connector 1 with the metal pads elastically connected with the corresponding contacts 12.

Because some flexible materials 431 formed at the bottom surface 430 of the pressing portion 43 act as a cushion, so the loading plate 40 formed from rigid materials won't contact the IHS of the chip 60 directly. Thus, the IHS of the chip 60 is prevented from being scraped by the loading plate 40 when the loading plate 40 pressing the chip 60 against the connector 1.

Although the invention has been described with respect to certain preferred embodiments, those skilled in the art will recognize that changes could be made without departing from the spirit and scope of the invention. For example, the housing and the reinforcement could be integrated into a single unit as a base, depending upon the needs of the user. Also, the loading plate could use other fastness techniques known in the art, such as screwing, to replace the actuator member locking the loading plate. Accordingly, it is appropriate that the appended claims be construed broadly and in a manner consistent with the scope of the invention.

1. An electrical connector for electrically nesting an electronic package, the electrical connector comprising:
a base;
a plurality of contacts received in said base;
a loading plate mounted to said base for holding the electronic package on the base, the loading plate defining a pressing portion having a bottom surface pressed the electronic package against the base;
wherein the bottom surface is attached with flexible material.

2. The electrical connector as claimed in claim 1, wherein the loading plate comprises a first side, a second side and a pair of lateral side interconnecting the first side with the second side.

3. The electrical connector as claimed in claim 2, wherein the pressing portion is defined on the lateral side.

4. The electrical connector as claimed in claim 3, wherein the pressing portion protrudes toward the housing.

5. The electrical connector as claimed in claim 1, wherein said base further comprises a housing for receiving the contacts therein and a reinforcement partly covering and reinforcing the housing;

6. The electrical connector as claimed in claim 5, wherein the connector further comprises an actuator member for locking the loading plate.

7. The electrical connector as claimed in claim 6, wherein the loading plate and the actuator member are pivotally mounted to two opposite ends of the reinforcement.

8. An electrical connector assembly, comprising;
an electronic package;
an electrical connector for nesting the electrical package, comprising;
a base;
a multiplicity of contacts accommodated in said base;
a loading plate attached to said base for holding the electronic package on the base, the loading plate defining a pressing portion have a bottom surface pressed the electronic package against the base;
wherein the bottom surface is attached with flexible material that the pressing portion contacts the electronic package indirectly.

9. The electrical connector assembly as claimed in claim 8, wherein the loading plate comprises a first side, a second side and a pair of lateral side interconnecting the first side with the second side.

10. The electrical connector assembly as claimed in claim 9, wherein the pressing portion is defined on each lateral side.

11. The electrical connector assembly as claimed in claim 10, wherein the pressing portion protrudes toward the housing.

12. The electrical connector assembly as claimed in claim 8, wherein said base further comprises a housing for receiving the contacts therein and a reinforcement partly covering and reinforcing the housing;

13. The electrical connector assembly as claimed in claim 12, wherein the connector further comprises an actuator member for locking the loading plate.

14. The electrical connector assembly as claimed in claim 13, wherein the loading plate and the actuator member are pivotally mounted to two opposite ends of the reinforcement.

15. An electrical connector assembly, comprising;
an electronic package; and
an electrical connector comprising;
a base defining a receiving space receiving said electronic package;
a multiplicity of contacts accommodated in said base and mechanically and electrically engaged with the electronic package;
a deflectable metallic loading plate pivotally attached to said base and defining a pressing portion pressing against a top face of the electronic package in a vertical direction; wherein
the pressing portion is equipped with non-metal material sandwiched between the pressing portion of the loading plate and the top face of the electronic package.

16. The electrical connector assembly as claimed in claim 15, wherein said non-metallic material is compressible in said vertical direction.

17. The electrical connector assembly as claimed in claim 15, wherein said non-metal material is insulative.
